(19) United States
(12) Patent Application Publication
(10) Pub. No.: US 2021/0150560 A1
(43) Pub. Date: May 20, 2021

(54) METHOD AND SYSTEM FOR LOYALTY POINTS MANAGEMENT

(71) Applicant: MASTERCARD INTERNATIONAL INCORPORATED, Purchase, NY (US)

(72) Inventors: Mrinal GUPTA, Alwar (IN); Nishita MARWAHA, Dwarka (IN); Simran HAATHIRAMANI, New Delhi (IN)

(21) Appl. No.: 17/074,838

(22) Filed: Oct. 20, 2020

(30) Foreign Application Priority Data
Nov. 15, 2019 (IN) 201921046491

(51) Int. Cl. G06Q 30/02; G06Q 30/00; G06Q 30/06

(52) U.S. Cl. CPC G06Q 30/0227; G06Q 30/0215; G06Q 30/0233; G06Q 30/0185; G06Q 40/02; G06Q 30/0635; G06Q 30/0631; G06Q 30/0641; G06Q 30/0206

(57) ABSTRACT

A method and a system for managing loyalty points of a user is provided. A plurality of loyalty accounts of the user are identified. Each of the plurality of loyalty accounts stores a first plurality of loyalty points. A conversion factor is determined for each loyalty account. Based on the conversion factor associated with each loyalty account, the first plurality of loyalty points of the corresponding loyalty account are converted to a second plurality of loyalty points. Further, a centralized account of the user is credited with a third plurality of loyalty points. The third plurality of loyalty points include the second plurality of loyalty points associated with each loyalty account. The credited third plurality of loyalty points are redeemable by the user.

### CROSS-REFERENCE TO RELATED APPLICATION

This application claims priority to Indian Patent Application No. 201921046491, filed Nov. 15, 2019, entitled “METHOD AND SYSTEM FOR LOYALTY POINTS MANAGEMENT”, the entirety of which is incorporated herein by reference.

### FIELD OF THE DISCLOSURE

Various embodiments of the disclosure relate generally to loyalty points management. More specifically, various embodiments of the disclosure relate to a method and a system for managing loyalty points of a user.

### BACKGROUND

Loyalty programs are widely used in a variety of industries to promote consumer loyalty. Such loyalty programs are typically offered by merchants and issuers to reward users (i.e., consumers) for repeat business with the merchants and issuers. Further, the merchants and issuers maintain corresponding loyalty accounts of the users for accumulating rewards (i.e., loyalty points) earned by the users. For example, the users earn the loyalty points by making e-commerce or retail purchases at the merchants or by utilizing payment modes issued by the issuers for making the purchases. The loyalty points are typically calculated using a predetermined formula or ratio that relates a purchase amount to a number of loyalty points. For example, the loyalty points may be issued on a one-for-one basis with each dollar that the users spend on the purchases. The earned loyalty points can then be redeemed in various ways. For example, the earned loyalty points may be redeemed for a discount against a purchase, a cashback equivalent to the redeemed loyalty points, an equivalent cash amount, or other loyalty point benefits.

While the loyalty programs have been successful, they have shortcomings of their own. Each merchant and issuer offer a separate loyalty program, and the loyalty points earned at a merchant or an issuer can be redeemed exclusively at the same merchant or the issuer on reward products offered by the merchant or the issuer. However, it is often difficult for an individual merchant or issuer to offer a sufficiently wide range of products to satisfy varied interests of the users. Additionally, the users may not be interested in redeeming the loyalty points for any of the limited products offered by the merchant or issuer. Further, it is difficult for a user to keep track of the loyalty points stored in each loyalty account of the user. This inadvertently results in expiry of the loyalty points, and the user misses out on various loyalty point benefits.

In light of the foregoing, there exists a need for a solution that solves the abovementioned problems and provides a loyalty program that efficiently manages loyalty points earned by a user at various merchants and issuers.

### SUMMARY

In an embodiment of the disclosure, a loyalty points management method is provided. A plurality of loyalty accounts of a user are identified by a server. Each of the plurality of loyalty accounts stores a first plurality of loyalty points. The server determines a conversion factor for each loyalty account of the plurality of loyalty accounts. Based on the conversion factor associated with each loyalty account, the server converts the first plurality of loyalty points of the corresponding loyalty account to a second plurality of loyalty points. Further, the server credits a centralized account of the user with a third plurality of loyalty points. The third plurality of loyalty points include the second plurality of loyalty points associated with each loyalty account. The credited third plurality of loyalty points are redeemable by the user.

In another embodiment of the disclosure, a loyalty points management system is provided. The loyalty points management system includes a server that is configured to identify a plurality of loyalty accounts of a user. Each of the plurality of loyalty accounts stores a first plurality of loyalty points. The server is further configured to determine a conversion factor for each loyalty account of the plurality of loyalty accounts. Based on the conversion factor associated with each loyalty account, the server is further configured to convert the first plurality of loyalty points of the corresponding loyalty account to a second plurality of loyalty points. The server is further configured to credit a centralized account of the user with a third plurality of loyalty points. The third plurality of loyalty points include the second plurality of loyalty points associated with each loyalty account. Further, the credited third plurality of loyalty points are redeemable by the user.

### BRIEF DESCRIPTION OF DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the disclosure are illustrated by way of example, and not limited by the appended figures, in which like references indicate similar elements:

FIG. 1 is a block diagram that illustrates an exemplary environment for managing loyalty points of users, in accordance with an exemplary embodiment of the disclosure;

FIGS. 2A and 2B, collectively represent a process flow diagram that illustrates an exemplary scenario for collating loyalty points in a centralized account of a user, in accordance with an exemplary embodiment of the disclosure;

FIGS. 3A and 3B, collectively represent a process flow diagram that illustrates an exemplary scenario for redeeming the loyalty points stored in the centralized account of the user, in accordance with an exemplary embodiment of the disclosure;

FIG. 4 represents a process flow diagram that illustrates an exemplary scenario for presenting purchase recommendations to the user, in accordance with an exemplary embodiment of the disclosure;

FIG. 5 is a table that illustrates collation of loyalty points in the centralized account of the user, in accordance with an exemplary embodiment of the disclosure;

FIG. 6A is a block diagram that illustrates a first user interface (UI) rendered on a user device of the environment of FIG. 1, in accordance with an exemplary embodiment of the disclosure;

FIG. 6B is a block diagram that illustrates a second UI rendered on the user device, in accordance with an exemplary embodiment of the disclosure;

FIG. 7 is a block diagram that illustrates a loyalty points management server of the environment of FIG. 1, in accordance with an exemplary embodiment of the disclosure;

FIG. 8 is a block diagram that illustrates system architecture of a computer system, in accordance with an exemplary embodiment of the disclosure;

FIGS. 9A-9C, collectively represent a flow chart that illustrates a loyalty points management method for collating the loyalty points in the centralized account of the user, in accordance with an exemplary embodiment of the disclosure;

FIG. 10 represents a flow chart that illustrates a method for redeeming the loyalty points stored in the centralized account of the user, in accordance with an exemplary embodiment of the disclosure;

FIG. 11 represents a flow chart that illustrates a method for presenting the purchase recommendations to the user, in accordance with an exemplary embodiment of the disclosure; and

FIG. 12 represents a high-level flow chart that illustrates a method for loyalty points management, in accordance with an exemplary embodiment of the disclosure.

Further areas of applicability of the disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Loyalty programs are typically facilitated by merchants and issuers to reward users (i.e., consumers) with loyalty points for repeat business with the merchants and issuers. The loyalty points can then be redeemed for various loyalty point benefits. However, each merchant and issuer facilitate a separate loyalty program, and the loyalty points earned at a merchant or issuer can be redeemed exclusively at the same merchant or issuer. The users, on the other hand, may not be interested in redeeming the loyalty points at the same merchant or issuer. Further, it is difficult for a user to keep track of loyalty points associated with multiple loyalty programs, resulting in expiry of the earned loyalty points. The user thus misses out on various loyalty point benefits.

Various embodiments of the disclosure provide a method and a system to solve the abovementioned problems by managing loyalty points of the users. A loyalty points management (LPM) server offers a centralized loyalty program. Various merchants and issuers are registered with the LPM server for the centralized loyalty program. Each registered merchant and issuer manage loyalty accounts of various users. An objective of the centralized loyalty program is to collate loyalty points stored in various loyalty accounts of a registered user, maintained at the registered merchants and/or issuers, in a centralized account of the registered user maintained at the LPM server.

A user initiates registration for the centralized loyalty program by providing a user identifier of the user to the LPM server. Based on the user identifier, the LPM server identifies various loyalty accounts of the user associated with the user identifier. The identified loyalty accounts may be maintained at one or more registered merchants and/or issuers. Further, the LPM server creates a centralized account of the user and links the centralized account to the identified loyalty accounts of the user. The user is thus registered with the LPM server for the centralized loyalty program.

The LPM server then determines loyalty points (i.e., a first plurality of loyalty points) stored in each of the identified loyalty accounts based on the link between the identified loyalty accounts and the centralized account. Further, the LPM server determines a conversion factor for each of the identified loyalty accounts. Based on the conversion factor determined for each of the identified loyalty accounts, the LPM server converts the loyalty points (i.e., the first plurality of loyalty points) stored in each of the identified loyalty accounts to loyalty points (i.e., a second plurality of loyalty points) associated with the centralized account. The centralized account is then credited with all the converted loyalty points (i.e., a third plurality of loyalty points). Thus, the centralized account stores the sum of the converted loyalty points (i.e., the second plurality of loyalty points) of all the identified loyalty accounts of the user. Further, based on the credit of loyalty points to the centralized account, the loyalty points stored in the identified loyalty accounts are debited.

The LPM server further facilitates redemption of the loyalty points stored in the centralized account at all the registered merchants and issuers. Additionally, the LPM server presents various purchase recommendations to the user for earning additional loyalty points in the centralized account of the user, which may enable the user to fulfil a wish list of the user.

The loyalty points stored in the centralized account are redeemable at all the registered merchants and issuers. The user may thus redeem the loyalty points earned at one merchant at any other registered merchant or issuer, even if the merchant or issuer does not manage a loyalty account of the user. Further, the loyalty points stored in the centralized account do not expire, i.e., the loyalty points are available until the loyalty points are redeemed. This ensures that the user does not miss out on any loyalty point benefits. Further, the collation of the loyalty points in the centralized account makes it easy for the user to keep track of all the loyalty points earned by the user at various merchants and issuers. Thus, the centralized loyalty program of the disclosure manages the loyalty points of the user in a more efficient manner as compared to conventional loyalty programs.

### Terms Description (in Addition to Plain and Dictionary Meaning)

Loyalty points are rewards earned by a user for making e-commerce or retail purchases at various merchants, utilizing payment modes issued by issuers for making the purchases, viewing multimedia items (e.g., videos, advertisements, or the like) presented on web or mobile applications hosted by the merchants or the issuers, or the like. The earned loyalty points may be redeemed by the user at any merchant or issuer registered for a centralized loyalty program. The loyalty points may be redeemed for availing a discount, an equivalent cashback, an equivalent cash amount, or the like.

Loyalty account is an account of a user that stores loyalty points earned by the user at a merchant or an issuer. The loyalty account may be maintained at the merchant or the issuer. The loyalty points may be debited from the loyalty account when the loyalty points are collated in a centralized account of the user.

Centralized account is an account of a user that is maintained at a loyalty points management (LPM) server. The centralized account is created by the LPM server when the user registers for a centralized loyalty program facilitated by the LPM server. Further, the centralized account is linked to various loyalty accounts of the user, and loyalty points stored in all the loyalty accounts of the user are collated in the centralized account. The collated loyalty points are redeemable by the user at all merchants and issuers registered with the LPM server for the centralized loyalty program.

Conversion factor for a loyalty account of a user defines an equivalence between loyalty points stored in the loyalty account and loyalty points associated with a centralized account of the user. Based on the conversion factor, the loyalty points of the loyalty account are converted to the loyalty points of the centralized account. For example, if the loyalty account stores 500 loyalty points and the conversion factor is 1.2, the 500 loyalty points of the loyalty account are converted to 600 loyalty points (i.e., 500*1.2=600) of the centralized account. The conversion factor for each loyalty account is determined based on a spend history of a merchant or an issuer managing the corresponding loyalty account. The conversion factor is dynamic. In other words, based on any change in the spend history of the corresponding merchant or issuer, the conversion factor may also change.

Spend history of a merchant or an issuer corresponds to volume of business completed by the merchant or the issuer during a predefined time period. The volume of business may correspond to sales of various products, issuance of various payment modes, or the like. Conversion factors for loyalty accounts maintained at merchants and issuers are determined based on spend histories of the merchants and issuers. For example, if the volume of business completed by a first merchant is greater than that completed by a second merchant, the conversion factor for the first merchant is greater than the conversion factor for the second merchant. Further, any changes in the spend histories of the merchants and issuers results in changes in the corresponding conversion factors.

Redemption value corresponds to a value of loyalty points of a centralized account of a user in terms of loyalty points of a loyalty account of the user. The loyalty account may be maintained at a merchant or an issuer registered for a centralized loyalty program. The redemption value may be determined based on a redemption factor that defines an equivalence between the loyalty points in the centralized account and the loyalty points associated with the registered merchant or issuer. The redemption value assists the user in selecting a registered merchant or a registered issuer for redeeming the loyalty points stored in the centralized account.

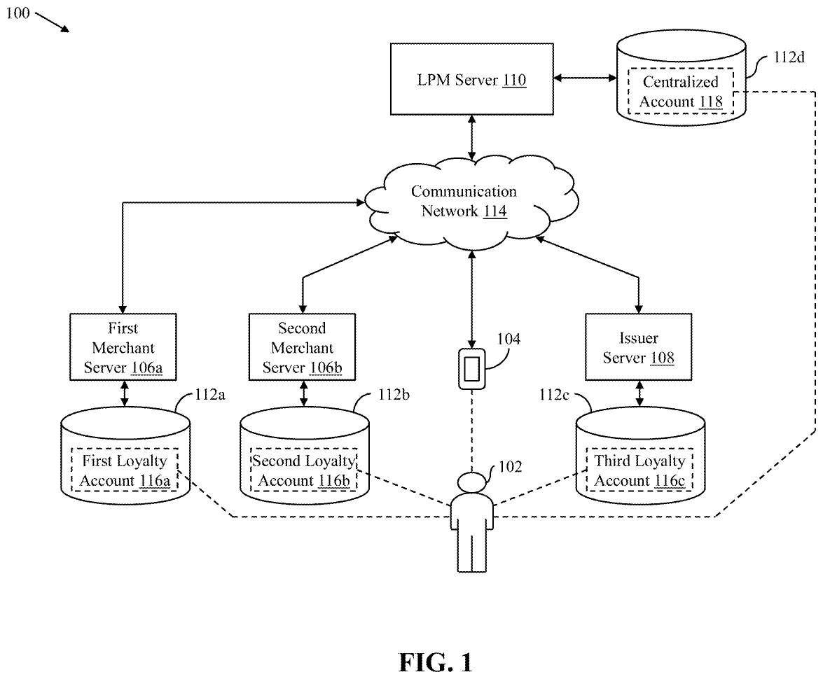

FIG. 1 is a block diagram that illustrates an exemplary environment 100 for managing loyalty points of users, in accordance with an exemplary embodiment of the disclosure. The environment 100 includes a user 102 and a user device 104 of the user 102. The environment 100 further includes first and second merchant servers 106a and 106b, an issuer server 108, and a loyalty points management (LPM) server 110. The environment 100 further includes first through fourth databases 112a-112d associated with the first and second merchant servers 106a and 106b, the issuer server 108, and the LPM server 110, respectively. The user device 104, the first and second merchant servers 106a and 106b, the issuer server 108, and the LPM server 110 communicate with each other by way of a communication network 114 or through separate communication networks established therebetween.

The user 102 is an individual, who performs various activities for earning loyalty points. Examples of such activities may include making e-commerce or retail purchases at various merchants, utilizing payment modes issued by various issuers for making the purchases, viewing multimedia items (e.g., videos, advertisements, or the like) presented on web or mobile applications hosted by the merchants or the issuers, or the like. The user 102 may be an account holder of various loyalty accounts maintained at the merchants and the issuers for storing the loyalty points earned by the user 102 at the merchants and the issuers, respectively. For the sake of brevity, it is assumed that the user 102 is an account holder of first through third loyalty accounts 116a-116c maintained at a first merchant, a second merchant, and a first issuer, respectively. Loyalty points earned by the user 102 for purchases made at the first and second merchants are stored in the first and second loyalty accounts 116a and 116b, respectively. Similarly, loyalty points earned by the user 102 due to the purchases made by using a payment mode issued by the first issuer, are stored in the third loyalty account 116c. Further, the first through third loyalty accounts 116a-116c are associated with a unique user identifier of the user 102. Examples of the user identifier may include a contact number of the user 102, an electronic mail identifier (e-mail id) of the user 102, a unique username of the user 102, or the like.

The user 102 may register with the LPM server 110 for a centralized loyalty program facilitated by the LPM server 110. The user 102 registers with the LPM server 110 by providing the user identifier to the LPM server 110. Upon registration, all loyalty accounts (i.e., the first through third loyalty accounts 116a-116c) of the user 102, associated with the user identifier, are linked to a centralized account 118 of the user 102 created by the LPM server 110. Thus, the user identifier of the user 102 is linked to the centralized account 118. Further, the loyalty points (i.e., a first plurality of loyalty points) stored in each of the first through third loyalty accounts 116a-116c are collated in the centralized account 118. The loyalty points stored in the centralized account 118 are redeemable by the user 102 and are available in the centralized account 118 until redemption.

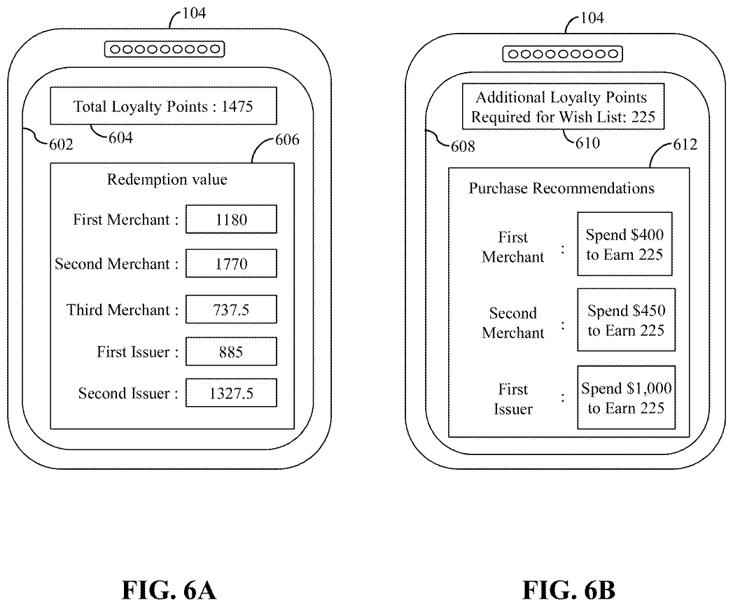

The user device 104 is a communication device of the user 102. Various user interfaces (UIs) (as shown in FIGS. 6A and 6B) are rendered on the user device 104 by the LPM server 110. The UIs may be rendered for presenting, to the user 102, information associated with the loyalty points stored in the centralized account 118, information associated with the redemption of the loyalty points stored in the centralized account 118, or the like. Additionally, the UIs may present various purchase recommendations to the user 102 for earning additional loyalty points in the centralized account 118. Examples of the user device 104 may include a smartphone, a personal computer, a laptop, a tablet, a phablet, or the like.

The first and second merchant servers 106a and 106b are computing servers that are operated by the first and second merchants, respectively. The first and second merchant servers 106a and 106b may include suitable logic, circuitry, interfaces, and/or code, executed by the circuitry, for managing the first and second loyalty accounts 116a and 116b, respectively. The first and second merchants are registered with the LPM server 110 for the centralized loyalty program. When the user 102 makes a purchase at the first merchant, the first merchant server 106a credits loyalty points associated with the purchase to the first loyalty account 116a. It will be apparent to a person skilled in the art that the number of loyalty points to be credited may be determined based on a formula or ratio set by the first merchant. For example, the loyalty points may be issued on a one-for-one basis with each dollar that the user 102 spends on the purchase. The second merchant server 106b similarly credits loyalty points to the second loyalty account 116b. Further, the first and second merchant servers 106a and 106b facilitate the redemption of the loyalty points stored in the centralized account 118.

The issuer server 108 is a computing server that is operated by the first issuer. The issuer server 108 may include suitable logic, circuitry, interfaces, and/or code, executed by the circuitry, for managing the third loyalty account 116c. The first issuer is a financial institution that issues various payment modes to users (such as the user 102). The first issuer is registered with the LPM server 110 for the centralized loyalty program. When the user 102 makes a purchase by utilizing the payment mode issued by the first issuer, the issuer server 108 credits loyalty points associated with the purchase to the third loyalty account 116c. Further, the issuer server 108 facilitates the redemption of the loyalty points stored in the centralized account 118.

The first through third databases 112a-112c are associated with the first merchant server 106a, the second merchant server 106b, and the issuer server 108, respectively. The first through third databases 112a-112c may include suitable logic, circuitry, and/or interfaces to store information pertaining to the first through third loyalty accounts 116a-116c, respectively. For the sake of brevity, the first through third databases 112a-112c are shown to store the information pertaining to the first through third loyalty accounts 116a-116c, respectively. In actual implementation, the first through third databases 112a-112c may be configured to store information pertaining to a plurality of loyalty accounts created by the first merchant server 106a, the second merchant server 106b, and the issuer server 108, respectively, for a plurality of users. Examples of the first through third databases 112a-112c may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the first through third databases 112a-112c working in conjunction with the first merchant server 106a, the second merchant server 106b, and the issuer server 108, respectively, as described herein. In another embodiment, the first through third databases 112a-112c may be realized in form of memories in the first merchant server 106a, the second merchant server 106b, and the issuer server 108, respectively, without departing from the scope of the disclosure.

The LPM server 110 is a computing server that includes suitable logic, circuitry, interfaces, and/or code, executed by the circuitry, for managing the centralized loyalty program. Various merchants (such as the first and second merchants) and issuers (such as the first issuer) are registered with the LPM server 110 for the centralized loyalty program. An objective of the centralized loyalty program is to collate loyalty points stored in various loyalty accounts of a registered user, maintained at the registered merchants and/or issuers, in a centralized account of the registered user maintained at the LPM server 110.

When the user 102 initiates the registration for the centralized loyalty program, the LPM server 110 receives the user identifier of the user 102. Based on the user identifier, the LPM server 110 identifies various loyalty accounts of the user 102 (such as the first through third loyalty accounts 116a-116c). Upon identification of the loyalty accounts of the user 102, the LPM server 110 creates the centralized account 118 for the user 102 and links the centralized account 118 to the loyalty accounts of the user 102. In an embodiment, the LPM server 110 stores information pertaining to a link between the centralized account 118 and the loyalty accounts of the user 102 in the fourth database 112d.

The LPM server 110 determines a conversion factor for each loyalty account of the user 102 based on a spend history of the merchant or the issuer maintaining the corresponding loyalty account. For example, the conversion factor for the first loyalty account 116a is determined based on a spend history of the first merchant. The conversion factor for each loyalty account defines an equivalence between the loyalty points of the corresponding loyalty account and the loyalty points of the centralized account 118. The spend history of the merchant or the issuer corresponds to volume of business completed by the merchant or the issuer during a predefined time period. The volume of business may correspond to sales of various products, issuance of various payment modes, or the like. In an example, if the volume of business completed by the first merchant is greater than that completed by the second merchant, the conversion factor for the first merchant is greater than the conversion factor for the second merchant.

Based on the conversion factor for each loyalty account of the user 102, the LPM server 110 converts the loyalty points (i.e., the first plurality of loyalty points) stored in each loyalty account to loyalty points (i.e., a second plurality of loyalty points) associated with the centralized account 118. The LPM server 110 then credits the converted loyalty points (i.e., the second plurality of loyalty points) of each loyalty account of the user 102 to the centralized account 118. The credited loyalty points (i.e., a third plurality of loyalty points) in the centralized account 118 are thus a summation of the converted loyalty points (i.e., the second plurality of loyalty points) of each of the first through third loyalty accounts 116a-116c.

The LPM server 110 further facilitates the redemption of the loyalty points stored in the centralized account 118. The loyalty points stored in the centralized account 118 may be redeemed against a purchase at the first merchant, the second merchant, the first issuer, or any other merchant or issuer registered with the LPM server 110 for the centralized loyalty program. The LPM server 110 may receive redemption requests by way of the first merchant server 106a, the second merchant server 106b, the issuer server 108, or a server (not shown) operated by any other registered merchant or issuer. The LPM server 110 initiates the redemption by debiting the requested loyalty points from the centralized account 118.

The LPM server 110 may be maintained at the first merchant, the second merchant, the first issuer, any other registered merchant or issuer, a payment network (e.g., Mastercard®), or a third-party service provider. When the LPM server 110 is maintained at the first merchant, the functionalities of the LPM server 110 may be integrated into the first merchant server 106a. Similarly, when the LPM server 110 is maintained at the second merchant or the first issuer, the functionalities of the LPM server 110 may be integrated into the second merchant server 106b or the issuer server 108, respectively.

Examples of the first and second merchant servers 106a and 106b, the issuer server 108, and the LPM server 110 may include, but are not limited to, personal computers, laptops, mini-computers, mainframe computers, any non-transient and tangible machine that can execute a machine-readable code, cloud-based servers, distributed server networks, or a network of computer systems. The first and second merchant servers 106a and 106b, the issuer server 108, and the LPM server 110 may be realized through various web-based technologies such as, but not limited to, a Java web-framework, a .NET framework, a personal home page (PHP) framework, or any other web-application framework.

The fourth database 112d is associated with the LPM server 110. The fourth database 112d may include suitable logic, circuitry, and/or interfaces to store information pertaining to the centralized account 118. For the sake of brevity, the fourth database 112d is shown to store the information pertaining to the centralized account 118 of the user 102. In actual implementation, the fourth database 112d may be configured to store information pertaining to a plurality of centralized accounts created by the LPM server 110 for a plurality of users. The fourth database 112d further stores the link between the centralized account 118 and the loyalty accounts of the user 102. The fourth database 112d is similar to the first through third databases 112a-112c.

The communication network 114 is a medium through which content and messages are transmitted between the user device 104, the first and second merchant servers 106a and 106b, the issuer server 108, the LPM server 110, or other entities in the in the environment 100. Examples of the communication network 114 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

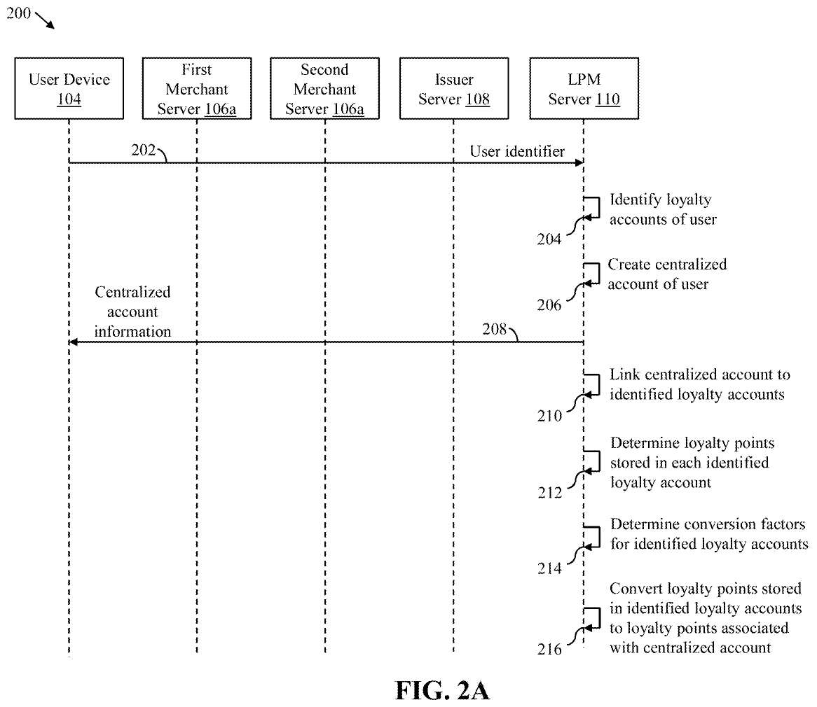

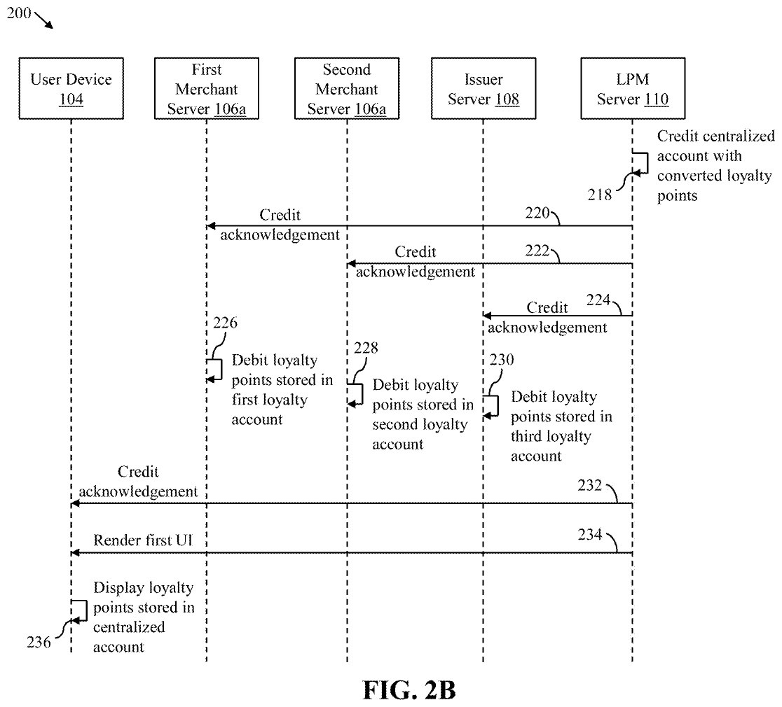

FIGS. 2A and 2B, collectively represent a process flow diagram 200 that illustrates an exemplary scenario for collating loyalty points in the centralized account 118 of the user 102, in accordance with an exemplary embodiment of the disclosure. The LPM server 110 facilitates the centralized loyalty program for managing loyalty points of users (such as the user 102).

The user 102 initiates the registration for the centralized loyalty program by providing the user identifier of the user 102. In an example, the user 102 may initiate the registration by logging on to a service application running or executed on the user device 104. The service application is hosted by the LPM server 110. In another example, the user 102 may initiate the registration at a registered merchant or a registered issuer. In another example, the user 102 may initiate the registration by logging on to a web application hosted by the LPM server 110. For the sake of brevity, it is assumed that the user 102 initiates the registration by logging on to the service application running on the user device 104 and providing the user identifier by way of the service application.

With reference to FIG. 2A, the LPM server 110 receives the user identifier from the user device 104 (as shown by arrow 202). The LPM server 110 identifies the loyalty accounts of the user 102 (i.e., the first through third loyalty accounts 116a-116c) based on the user identifier (as shown by arrow 204). In an embodiment, the LPM server 110 may communicate a first query to all the registered merchants and issuers for identifying the loyalty accounts that are associated with the user identifier. The first query includes the user identifier of the user 102. Further, the LPM server 110 identifies the loyalty accounts of the user 102 based on responses to the first query received from the registered merchants and issuers. Each response may indicate whether the corresponding merchant or issuer manages a loyalty account of the user 102.

To register the user 102 for the centralized loyalty program, the LPM server 110 creates the centralized account 118 of the user 102 (as shown by arrow 206). The LPM server 110 communicates information of the centralized account 118 (such as an account identifier of the centralized account 118) to the user device 104 for notifying the user 102 of the creation of the centralized account 118 (as shown by arrow 208). In an embodiment, the LPM server 110 communicates the information of the centralized account 118 (hereinafter referred to as the “centralized account information”) to the user device 104 by way of a short messaging service (SMS), an e-mail, an in-app notification (e.g., a push notification on the service application), or the like. Further, the LPM server 110 links the centralized account 118 to the first through third loyalty accounts 116a-116c (as shown by arrow 210). After linking the centralized account 118 to the first through third loyalty accounts 116a-116c, the centralized account 118 may serve as a loyalty points digital wallet for the first through third loyalty accounts 116a-116c. The user 102 is thus registered with the LPM server 110 for the centralized loyalty program.

The LPM server 110 then determines the loyalty points (i.e., the first plurality of loyalty points) stored in each of the first through third loyalty accounts 116a-116c based on the link between the first through third loyalty accounts 116a-116c and the centralized account 118 (as shown by arrow 212). In an embodiment, upon linking the centralized account 118 to the first through third loyalty accounts 116a-116c, the LPM server 110 may communicate a second query to each of the first merchant server 106a, the second merchant server 106b, and the issuer server 108 for determining the loyalty points (i.e., the first plurality of loyalty points) stored in each of the first through third loyalty accounts 116a-116c, respectively. The LPM server 110 determines the loyalty points stored in the first through third loyalty accounts 116a-116c based on responses to the second query received from the first merchant server 106a, the second merchant server 106b, and the issuer server 108, respectively.

The LPM server 110 determines first through third conversion factors for the first through third loyalty accounts 116a-116c, respectively (as shown by arrow 214). The first through third conversion factors are determined based on the spend histories of the first merchant, the second merchant, and the first issuer, respectively. Based on the first through third conversion factors, the LPM server 110 converts the loyalty points (i.e., the first plurality of loyalty points) stored in each of the first through third loyalty accounts 116a-116c to loyalty points (i.e., the second plurality of loyalty points) associated with the centralized account 118 (as shown by arrow 216).

With reference to FIG. 2B, the LPM server 110 credits the centralized account 118 with the converted loyalty points (i.e., the third plurality of loyalty points) of the first through third loyalty accounts 116a-116c (as shown by arrow 218). Thus, the centralized account 118 stores the sum of the converted loyalty points. In an exemplary scenario, the first loyalty account 116a may store 500 loyalty points, the second loyalty account 116b may store 1000 loyalty points, and the third loyalty account 116c may store 1500 loyalty points. The first through third conversion factors determined by the LPM server 110 for the first through third loyalty accounts 116a-116c may be 1.2, 0.5, and 0.25, respectively. In such a scenario, the LPM server 110 converts 500 loyalty points of the first loyalty account 116a to 600 loyalty points (i.e., 500*1.2=600) of the centralized account 118 and 1000 loyalty points of the second loyalty account 116b to 500 loyalty points (i.e., 1000*0.5=500) of the centralized account 118. The LPM server 110 further converts 1500 loyalty points of the third loyalty account 116c to 375 loyalty points (i.e., 1500*0.25=375) of the centralized account 118. Based on the conversion, the LPM server 110 credits the centralized account 118 with a sum of 600, 500, and 375 loyalty points. The centralized account 118 thus stores 1475 loyalty points (i.e., a summation of 600, 500, and 375 loyalty points).

The LPM server 110 communicates credit acknowledgements to the first merchant server 106a, the second merchant server 106b, and the issuer server 108 to indicate the credit of the centralized account 118 (as shown by arrows 220, 222, and 224, respectively). Upon reception of the credit acknowledgements, the first merchant server 106a, the second merchant server 106b, and the issuer server 108 debit the loyalty points (i.e., the first plurality of loyalty points) stored in each of the first through third loyalty accounts 116a-116c, respectively (as shown by arrows 226, 228, and 230). It will be apparent to a person skilled in the art that the scope of the disclosure is not limited to crediting the converted loyalty points to the centralized account 118 prior to debiting the loyalty points from the first through third loyalty accounts 116a-116c. In another embodiment, the loyalty points from the first through third loyalty accounts 116a-116c may be debited prior to or simultaneously with the credit of the converted loyalty points to the centralized account 118, without deviating from the scope of the disclosure. The LPM server 110 may also communicate the credit acknowledgment to the user device 104 to indicate the credit of the centralized account 118 (as shown by arrow 232). The LPM server 110 may further render a first UI (as shown in FIG. 6A) on the user device 104 for presenting the loyalty points stored in the centralized account 118 to the user 102 (as shown by arrow 234). The user device 104 thus displays the loyalty points stored in the centralized account 118 to the user 102 (as shown by arrow 236).

When the user 102 makes subsequent purchases from the first and second merchants, and utilizes the payment mode issued by the first issuer for making the subsequent purchases, loyalty points earned by the user 102 are credited to the first through third loyalty accounts 116a-116c, respectively. Since the centralized account 118 serves as the loyalty points digital wallet for the first through third loyalty accounts 116a-116c, the newly credited loyalty points of the first through third loyalty accounts 116a-116c are then automatically (i.e., sans any input from the user 102) collated in the centralized account 118 in a similar manner as described above.

Although the disclosure describes the user 102 as the account holder of the first through third loyalty accounts 116a-116c maintained at the first merchant, the second merchant, and the first issuer, respectively, the scope of the disclosure is not limited to it. In various other embodiments, the user 102 may hold more than two loyalty accounts maintained at merchants and more than one loyalty account maintained at issuers, without deviating from the scope of the disclosure.

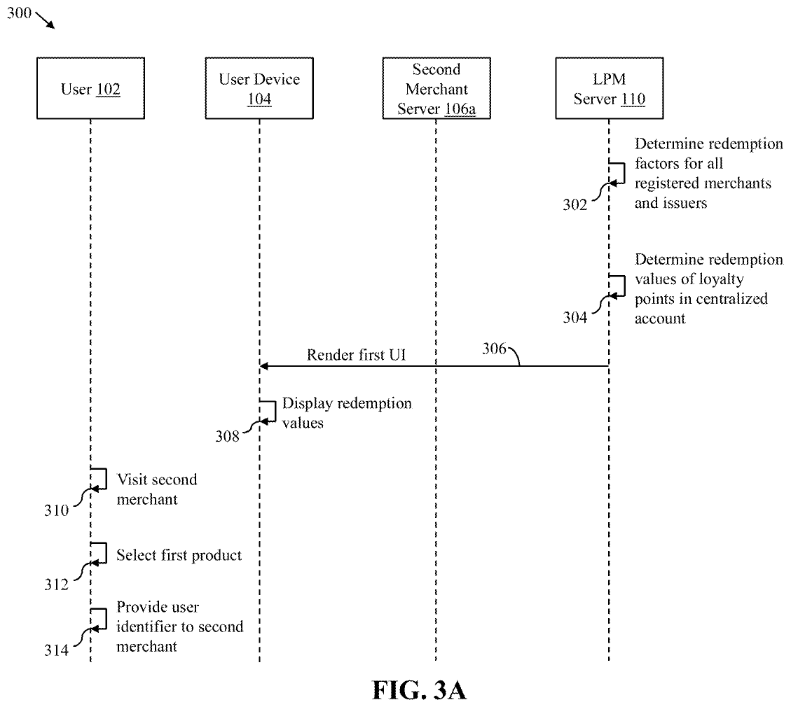

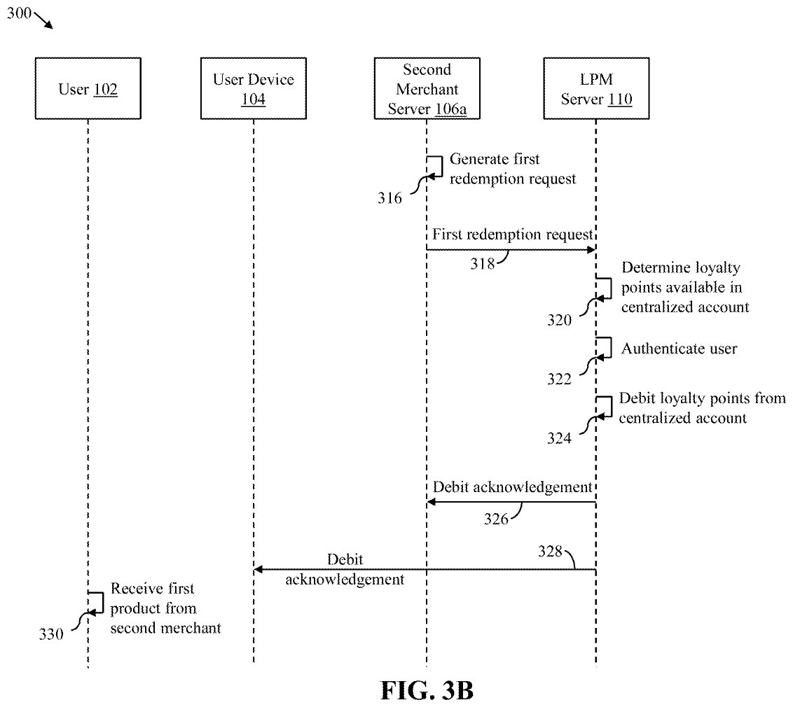

FIGS. 3A and 3B, collectively represent a process flow diagram 300 that illustrates an exemplary scenario for redeeming the loyalty points stored in the centralized account 118 of the user 102, in accordance with an exemplary embodiment of the disclosure.

With reference to FIG. 3A, the LPM server 110 determines redemption factors for all the registered merchants and issuers to enable the redemption of the loyalty points stored in the centralized account 118 at the registered merchants and issuers (as shown by arrow 302). A redemption factor for a registered merchant may define an equivalence between the loyalty points in the centralized account 118 and loyalty points associated with the registered merchant. The redemption factors for all the registered merchants and issuers are determined based on the spend histories of the registered merchants and issuers, respectively. In an example, a redemption factor for a registered merchant or issuer is same as a corresponding conversion factor. In another example, a redemption factor for a registered merchant or issuer is different than a corresponding conversion factor. Based on the determined redemption factors, the LPM server 110 determines redemption values of the loyalty points in the centralized account 118 for redemption at the registered merchants and issuers (as shown by arrow 304). The redemption of the loyalty points may correspond to a discount against a purchase, a cashback equivalent to the redeemed loyalty points, an equivalent cash amount, or one or more other loyalty point benefits that are known to a person of ordinary skill in the art.

In one exemplary scenario, the redemption factors for redeeming the loyalty points stored in the centralized account 118 at the first merchant, the second merchant, a registered third merchant (not shown), the first issuer, and a registered second issuer (not shown) may be 0.8, 1.2, 0.5, 0.6, and 0.9, respectively. In such a scenario, if the centralized account 118 stores 1475 loyalty points, the redemption value for redeeming 1475 loyalty points at the first merchant is 1180 loyalty points accepted by the first merchant (i.e. 1475*0.8=1180). Likewise, the redemption values for redeeming 1475 loyalty points at the second and third merchants, and the first and second issuers are 1770 loyalty points, 737.5 loyalty points, 885 loyalty points, and 1327.5 loyalty points, respectively.

Although FIGS. 3A and 3B describe that the loyalty points of the centralized account 118 may be redeemed at the second issuer that does not manage a loyalty account of the user 102, the scope of the disclosure is not limited to it. In various other embodiments, the user 102 may be presented with redemption values exclusively for issuers (e.g., the first issuer) that manage loyalty accounts of the user 102, without deviating from the scope of the disclosure.

The LPM server 110 renders the first UI on the user device 104 for presenting the determined redemption values to the user 102 (as shown by arrow 306). The user device 104 thus displays the determined redemption values to the user 102 (as shown by arrow 308). The presented redemption values thus assist the user 102 in selecting a registered merchant or a registered issuer for redeeming the loyalty points. For the sake of brevity, it is assumed that the user 102 chooses to redeem the loyalty points stored in the centralized account 118 at the second merchant. However, it will be apparent to a person skilled in the art that the user 102 may redeem the loyalty points stored in the centralized account 118 at the first merchant, the third merchant, the first issuer, the second issuer, or any other registered merchant or issuer, without deviating from the scope of the disclosure.

The user 102 visits the second merchant for making a purchase (as shown by arrow 310). The user 102 selects a first product for purchasing (as shown by arrow 312). The user 102 further provides the user identifier to the second merchant (or an operative associated with the second merchant) for initiating the redemption of the loyalty points stored in the centralized account 118 (as shown by arrow 314). Alternatively, the user 102 may provide the account identifier of the centralized account 118 for initiating the redemption of the loyalty points stored in the centralized account 118. The second merchant further provides the user identifier (or the account identifier) of the user 102 to the second merchant server 106b.

With reference to FIG. 3B, the second merchant server 106b generates the first redemption request (as shown by arrow 316). The second merchant server 106b transmits the first redemption request including the user identifier to the LPM server 110 (as shown by arrow 318). The LPM server 110 then determines the loyalty points available in the centralized account 118 (as shown by arrow 320). The LPM server 110 authenticates the user 102 for the redemption (as shown by arrow 322). In an example, the LPM server 110 authenticates the user 102 based on one-time passwords (OTPs).

Based on the authentication of the user 102, the LPM server 110 debits the loyalty points from the available loyalty points in the centralized account 118 (as shown by arrow 324). In an embodiment, all available loyalty points are debited. Thus, 1475 loyalty points stored in the centralized account 118 are redeemed as 1770 loyalty points at the second merchant. In another embodiment, a part of the available loyalty points is debited, where the part of the available loyalty points to be debited is determined based on a purchase amount of the first product. For example, if the purchase amount of the first product is equivalent to 1500 loyalty points associated with the second merchant, 1250 loyalty points are debited from the centralized account 118 (as 1250 loyalty points in the centralized account 118 are equivalent to 1500 loyalty points associated with the second merchant). Additionally, the part of the available loyalty points to be debited is determined based on one or more redemption constraints imposed by the LPM server 110. The redemption constraints may define a maximum number of loyalty points that may be redeemed at various merchants and issuers at any time instance for a certain amount of purchase.

The LPM server 110 communicates a debit acknowledgement to the second merchant server 106b to indicate the debit of the centralized account 118 (as shown by arrow 326). The LPM server 110 may additionally communicate the debit acknowledgement to the user device 104 (as shown by arrow 328). Thus, by redeeming the loyalty points, the user 102 may avail a discount or a cashback on the purchase of the first product. The user 102 further receives the purchased first product from the second merchant (as shown by arrow 330).

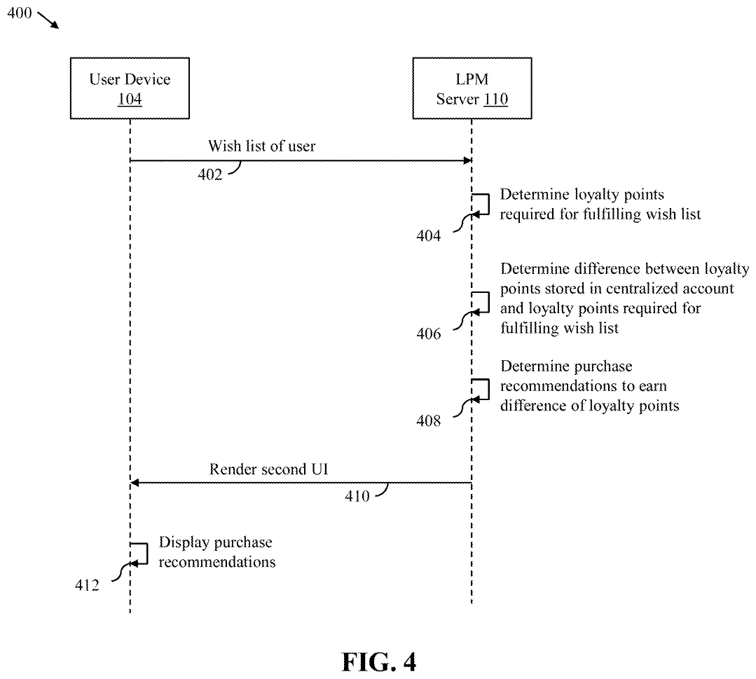

FIG. 4 represents a process flow diagram 400 that illustrates an exemplary scenario for presenting purchase recommendations to the user 102, in accordance with an exemplary embodiment of the disclosure. The LPM server 110 receives a wish list of the user 102 from the user device 104 (as shown by arrow 402). The wish list may include details of one or more products that the user 102 wishes to purchase. The LPM server 110 determines loyalty points (i.e., a fourth plurality of loyalty points) required for fulfilling the wish list (as shown by arrow 404). The LPM server 110 determines a difference of loyalty points between the loyalty points (i.e., the third plurality of loyalty points) stored in the centralized account 118 and the loyalty points (i.e., the fourth plurality of loyalty points) required for fulfilling the wish list (as shown by arrow 406). Further, the LPM server 110 determines various purchase recommendations for the user 102 to earn the difference of loyalty points (as shown by arrow 408). Each purchase recommendations may include a purchase amount, a registered merchant or issuer at which the corresponding purchase is to be made, or the like.

In one exemplary scenario, the wish list of the user 102 may include a second product that is worth 1700 loyalty points of the centralized loyalty program, and the centralized account 118 may store 1475 loyalty points. The difference of loyalty points is thus 225 loyalty points. In such a scenario, the LPM server 110 determines various purchase recommendations for the user 102 to earn 225 loyalty points in the centralized account 118. One of the purchase recommendations may indicate that 225 loyalty points may be earned in the centralized account 118 by spending $400 at the first merchant and earning 187.5 loyalty points in the first loyalty account 116a. 187.5 loyalty points in the first loyalty account 116a may then be converted to 225 loyalty points in the centralized account 118 (i.e., 187.5*1.2=225 loyalty points). Likewise, another purchase recommendation may indicate that 225 loyalty points may be earned in the centralized account 118 by spending $1,000 using the payment mode issued by the first issuer and earning 900 loyalty points in the third loyalty account 116c. 900 loyalty points in the third loyalty account 116c may then be converted to 225 loyalty points in the centralized account 118 (i.e., 900*0.25=225 loyalty points).

The LPM server 110 renders a second UI (as shown in FIG. 6B) on the user device 104 for presenting the purchase recommendations to the user 102 (as shown by arrow 410). The user device 104 thus displays the purchase recommendations to the user 102 (as shown by arrow 412). Additionally, the wish list may also be communicated by the LPM server 110 to various registered merchants and issuers. Based on the products included in the wish list, the corresponding merchants and issuers may provide various offers to the user 102. This may lead to reduction in number of loyalty points required for fulfilling the wish list.

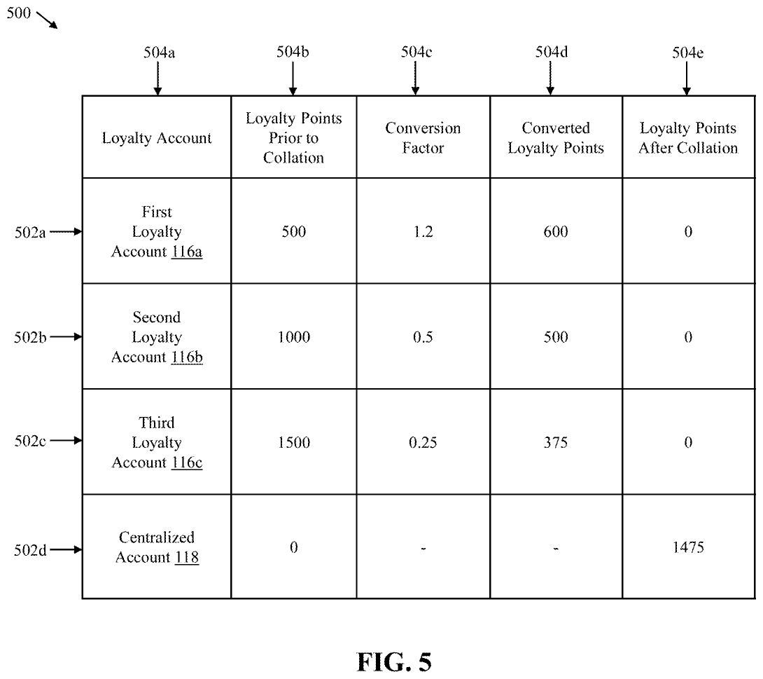

FIG. 5 is a table 500 that illustrates collation of loyalty points in the centralized account 118 of the user 102, in accordance with an exemplary embodiment of the disclosure. The table 500 includes rows 502a-502d and columns 504a-504e. The columns 504a-504e represent loyalty accounts, loyalty points in loyalty accounts prior to collation, conversion factors, converted loyalty points of loyalty accounts, and loyalty points in loyalty accounts after collation, respectively. The rows 502a-502d represent details pertaining to the columns 504a-504e for the first through third loyalty accounts 116a-116c and the centralized account 118, respectively.

As illustrated in table 500, the first loyalty account 116a stores 500 loyalty points, the second loyalty account 116b stores 1000 loyalty points, and the third loyalty account 116c stores 1500 loyalty points, prior to collation. Likewise, prior to the collation, the centralized account 118 may store 0 loyalty points. Further, the first through third conversion factors determined by the LPM server 110 for the first through third loyalty accounts 116a-116c are 1.2, 0.5, and 0.25, respectively. In such a scenario, the LPM server 110 converts 500 loyalty points of the first loyalty account 116a, 1000 loyalty points of the second loyalty account 116b, and 1500 loyalty points of the third loyalty account 116c to 600 loyalty points, 500 loyalty points, and 375 loyalty points of the centralized account 118, respectively. Based on the conversion, the LPM server 110 credits the centralized account 118 with 600, 500, and 375 loyalty points. The centralized account 118 thus stores 1475 loyalty points (i.e., a summation of 600, 500, and 375 loyalty points). Further, 500 loyalty points, 1000 loyalty points, and 1500 loyalty points are debited from the first through third loyalty accounts 116a-116c, respectively, based on the credit of 1475 loyalty points to the centralized account 118. Thus, after collation, the first through third loyalty accounts 116a-116c store 0 loyalty points, and the centralized account 118 stores 1475 loyalty points.

It will be apparent to a person of skill in the art that the conversion factors determined by the LPM server 110 are dynamic. In other words, based on any change in the spend history of a registered merchant or issuer, corresponding conversion factor may also change.

FIG. 6A is a block diagram that illustrates the first UI 602 rendered on the user device 104, in accordance with an exemplary embodiment of the disclosure. The first UI 602 is rendered on the user device 104 by the LPM server 110 for presenting the loyalty points stored in the centralized account 118 and the redemption values of the stored loyalty points at various registered merchants and issuers.

The first UI 602 includes a first section 604 that displays the loyalty points (e.g., ‘1475’ loyalty points) stored in the centralized account 118. The first UI 602 further includes a second section 606 that displays redemption values of the stored loyalty points at various registered merchants and issuers. For the sake of brevity, redemption values of the stored loyalty points (e.g., 1475 loyalty points) is shown with respect to the first through third merchants and the first and second issuers. The second section 606 thus presents redemption values (e.g., ‘1180’ loyalty points, ‘1770’ loyalty points, ‘737.5’ loyalty points, ‘885’ loyalty points, and ‘1327.5’ loyalty points) for redeeming ‘1475’ loyalty points of the centralized account 118 at the first through third merchants and the first and second issuers, respectively. The redemption values for each registered merchant and issuer is determined based on the redemption factor of the corresponding registered merchant and issuer.

It will be apparent to a person of skill in the art that the redemption factors determined by the LPM server 110 are dynamic and may vary as per the change in the spend history of the registered merchants and issuers. Thus, the redemption values presented in the second section 606 are also dynamic and may be updated due to any change in the redemption factors.

FIG. 6B is a block diagram that illustrates the second UI 608 rendered on the user device 104, in accordance with an exemplary embodiment of the disclosure. The second UI 608 is rendered on the user device 104 by the LPM server 110 for presenting the purchase recommendations to the user 102.

The second UI 608 includes a third section 610 that displays additional loyalty points (e.g., ‘225’ loyalty points) required to fulfil the wish list of the user 102. The second UI 608 further includes a fourth section 612 that displays the purchase recommendations provided by the LPM server 110 to the user 102 for earning the additional loyalty points. For example, a first purchase recommendation may indicate that the user 102 may spend $400 at the first merchant to earn the additional loyalty points (i.e., 225 loyalty points) in the centralized account 118. Likewise, a second purchase recommendation may indicate that the user 102 may spend $450 at the second merchant to earn the additional loyalty points (i.e., 225 loyalty points) in the centralized account 118. Further, a third purchase recommendation may indicate that the user 102 may spend $1,000 using the payment mode issued by the first issuer to earn the additional loyalty points (i.e., 225 loyalty points) in the centralized account 118.

Although FIG. 6B describes that the purchase recommendations are provided exclusively for the registered merchants and issuers that manage a loyalty account of the user 102 (e.g., the first and second merchants and the first issuer), the scope of the disclosure is not limited to it. In various other embodiments, purchase recommendations may be provided for various other registered merchants and issuers that do not manage a loyalty account of the user 102, without deviating from the scope of the disclosure. In such a scenario, the user 102 may be required to register with the corresponding merchants and issuers for creation of a corresponding loyalty account of the user 102, and the created loyalty account may be linked to centralized account 118. The loyalty points credited to the newly created loyalty account may then be converted and credited to the centralized account 118 in a similar manner as described above.

It will be apparent to a person skilled in the art that the scope of the disclosure is not limited to the rendering of the first and second UIs 602 and 608. In various other embodiments of the disclosure, the UIs rendered on the user device 104 may vary in type and sequence, without deviating from the scope of the disclosure.

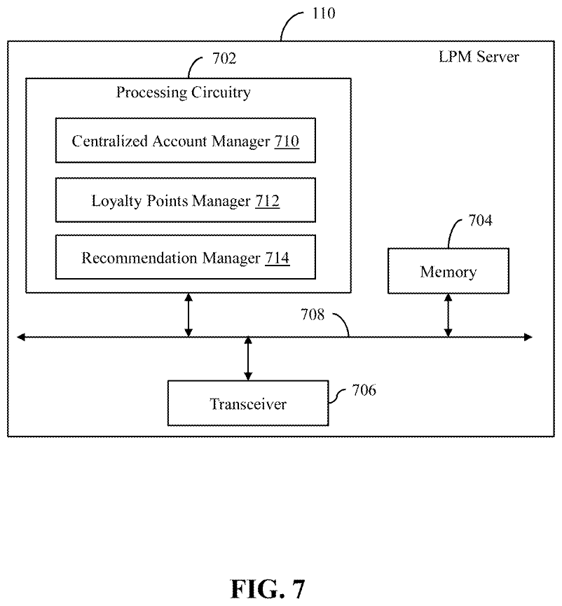

FIG. 7 is a block diagram that illustrates the LPM server 110, in accordance with an exemplary embodiment of the disclosure. The LPM server 110 includes processing circuitry 702, a memory 704, and a transceiver 706. The processing circuitry 702, the memory 704, and the transceiver 706 communicate with each other by way of a communication bus 708.

The processing circuitry 702 may include suitable logic, circuitry, interfaces, and/or code for managing the centralized loyalty program. The processing circuitry 702 may include a centralized account manager 710, a loyalty points manager 712, and a recommendation manager 714.

The centralized account manager 710 includes suitable logic, circuitry, interfaces, and/or code, executable by the circuitry for managing centralized accounts of various users (such as the user 102). When a user (such as the user 102) initiates the registration with the LPM server 110 for the centralized loyalty program, the centralized account manager 710 receives the user identifier of the user 102, and identifies the loyalty accounts of the user 102 (i.e., the first through third loyalty accounts 116a-116c) based on the user identifier. Further, the centralized account manager 710 creates the centralized account 118 of the user 102 and links the centralized account 118 to the identified loyalty accounts of the user 102. When loyalty points are collated in the centralized account 118, the centralized account manager 710 renders the first UI on the user device 104 for presenting, to the user 102, the loyalty points stored in the centralized account 118 and the redemption values of the stored loyalty points.

The centralized account manager 710 further initiates the redemption of the loyalty points by debiting the loyalty points from the centralized account 118 based on redemption requests. The centralized account manager 710 may additionally communicate the centralized account information, the credit and debit acknowledgements, or the like, to the user device 104 of the user 102. Examples of the centralized account manager 710 may include an application specific integrated circuit (ASIC) processor, a reduced instruction set computer (RISC) processor, a complex instruction set computer (CISC) processor, a field programmable gate array (FPGA), or the like.

The loyalty points manager 712 may include suitable logic, circuitry, interfaces, and/or code, executable by the circuitry for managing loyalty points of users (such as the user 102). The loyalty points manager 712 determines loyalty points stored in the first through third loyalty accounts 116a-116c that are linked to the centralized account 118. Further, the loyalty points manager 712 determines the first through third conversion factors for the first merchant, the second merchant, and the first issuer, respectively. Based on the first through third conversion factors, the loyalty points manager 712 converts the loyalty points stored in the first through third loyalty accounts 116a-116c to the loyalty points associated with the centralized account 118. Further, the loyalty points manager 712 credits the centralized account 118 with the converted loyalty points of the first through third loyalty accounts 116a-116c.

The loyalty points manager 712 determines the redemption factors for all the registered merchants and issuers for redeeming the loyalty points stored in the centralized account 118. Based on the determined redemption factors, the loyalty points manager 712 determines the redemption values of the loyalty points in the centralized account 118 for redemption at the registered merchants and issuers, respectively. Examples of the loyalty points manager 712 may include an ASIC processor, a RISC processor, a CISC processor, an FPGA, or the like.

The recommendation manager 714 includes suitable logic, circuitry, interfaces, and/or code, executable by the circuitry for presenting purchase recommendations to users (such as the user 102) for earning additional loyalty points. The recommendation manager 714 receives the wish list of the user 102 and determines the additional loyalty points required for fulfilling the wish list. The recommendation manager 714 determines the purchase recommendations for the user 102 to earn the additional loyalty points. The recommendation manager 714 may also render the second UI on the user device 104 for presenting the purchase recommendations to the user 102. Examples of the recommendation manager 714 may include an ASIC processor, a RISC processor, a CISC processor, an FPGA, or the like.

The memory 704 includes suitable logic, circuitry, and/or interfaces to store one or more instructions that are executed by the centralized account manager 710, the loyalty points manager 712, and the recommendation manager 714 for performing one or more operations. In one embodiment, the information stored in the fourth database 112d may be stored in the memory 704, without deviating from the scope of the disclosure. Examples of the memory 704 include a RAM, a ROM, a removable storage drive, an HDD, a flash memory, a solid-state memory, and the like.

The transceiver 706 includes suitable logic, circuitry, interfaces and/or code, executable by the circuitry, for transmitting and receiving data over the communication network 114 using one or more communication protocols. The transceiver 706 receives various requests and messages from the user device 104, the first merchant server 106a, the second merchant server 106b, the issuer server 108, and the servers operated by various other registered merchants and issuers. For example, the transceiver 706 receives the user identifier from the user device 104. Additionally, the transceiver 706 receives redemption requests from the first and second merchant servers 106a and 106b, the issuer server 108, and the servers operated by various other registered merchants and issuers.

The transceiver 706 transmits various requests and messages to the user device 104, the first merchant server 106a, the second merchant server 106b, the issuer server 108 and the servers operated by various other registered merchants and issuers. For example, the transceiver 706 communicates the centralized account information, the credit and debit acknowledgements, or the like, to the user device 104, the first merchant server 106a, the second merchant server 106b, and the issuer server 108. Examples of the transceiver 706 may include, but are not limited to, an antenna, a radio frequency transceiver, a wireless transceiver, an Ethernet port, a Universal Serial Bus (USB) port, or any other device configured to transmit and receive data.

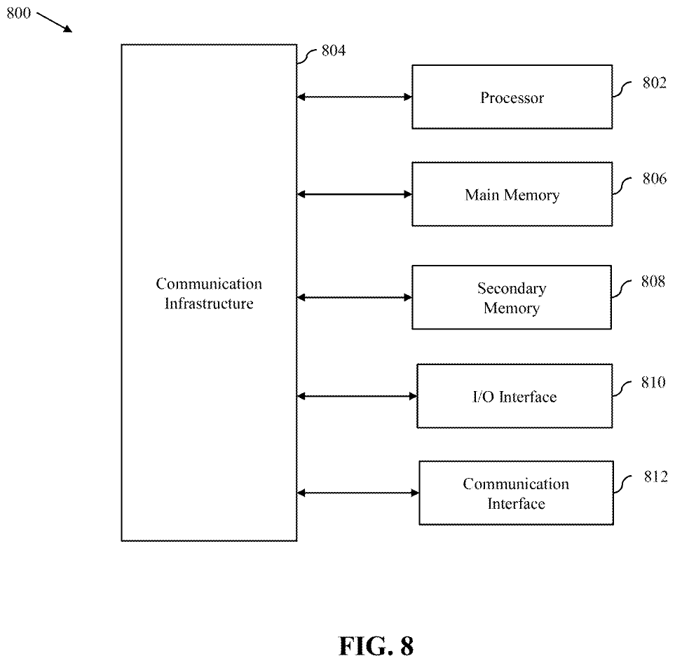

FIG. 8 is a block diagram that illustrates system architecture of a computer system 800, in accordance with an exemplary embodiment of the disclosure. An embodiment of disclosure, or portions thereof, may be implemented as computer readable code on the computer system 800. In one example, the user device 104, the first and second merchant servers 106a and 106b, the issuer server 108, and the LPM server 110 may be implemented as the computer system 800.

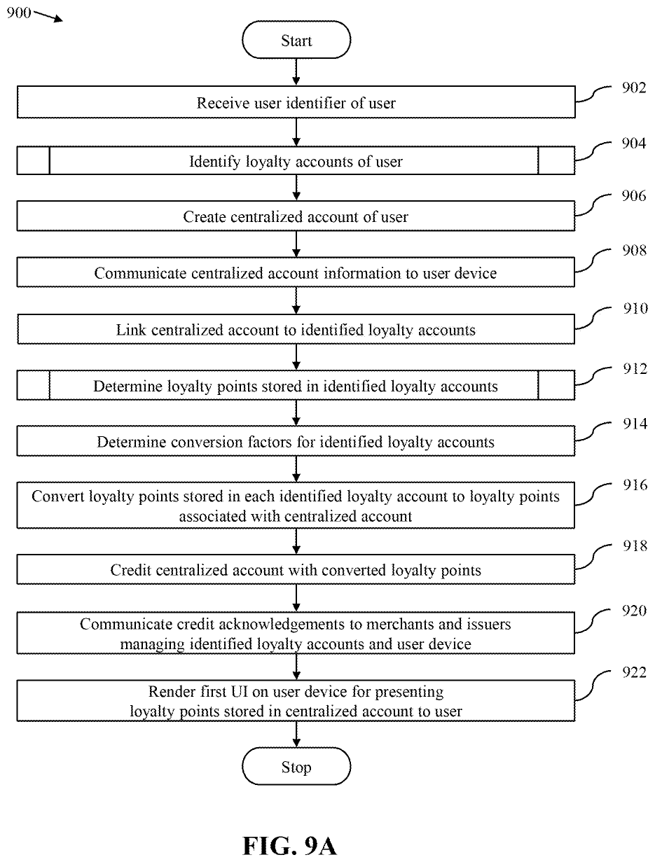

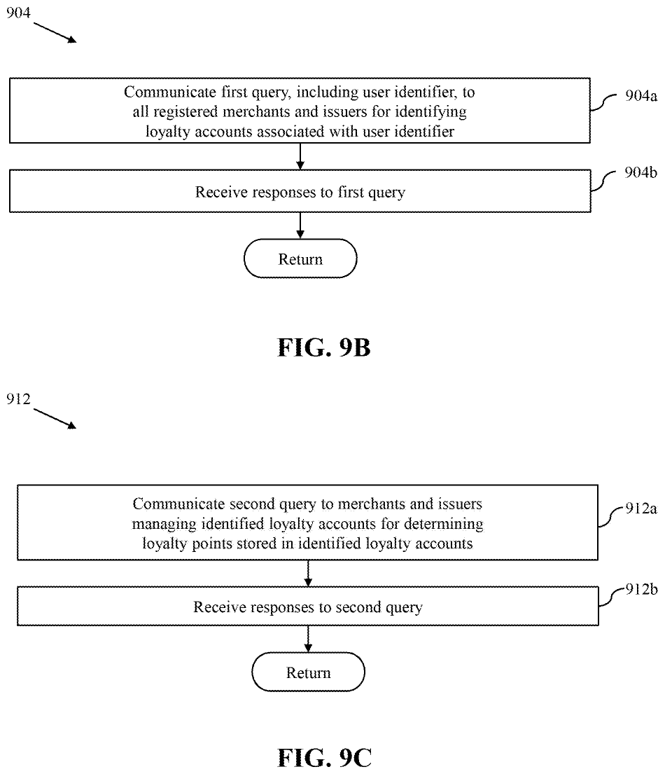

Hardware, software, or any combination thereof may embody modules and components used to implement methods of FIGS. 9A, 9B, and 10-12. The computer system 800 includes a processor 802 that may be a special-purpose or a general-purpose processing device. The processor 802 may be a single processor, multiple processors, or combinations thereof. Further, the processor 802 may be connected to a communication infrastructure 804, such as a bus, message queue, multi-core message-passing scheme, and the like. The computer system 800 may further include a main memory 806 and a secondary memory 808. Examples of the main memory 806 may include a RAM, a ROM, and the like. The secondary memory 808 may include an HDD or a removable storage drive, such as a floppy disk drive, a magnetic tape drive, a compact disc, an optical disk drive, a flash memory, and the like.

The computer system 800 further includes an input/output (I/O) interface 810 and a communication interface 812. The I/O interface 810 includes various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communications port, and the like. Data transferred via the communication interface 812 may correspond to signals, such as electronic, electromagnetic, optical, or other signals as will be apparent to a person skilled in the art.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment. In addition, in some embodiments, the order of operations may be rearranged without departing from the spirit of the disclosed subject matter.

FIGS. 9A-9C, collectively represent a flow chart 900 that illustrates a loyalty points management method for collating loyalty points in the centralized account 118 of the user 102, in accordance with an exemplary embodiment of the disclosure. The user 102 initiates the registration for the centralized loyalty program facilitated by the LPM server 110 by providing the user identifier of the user 102. For the sake of brevity, it is assumed that the user 102 initiates the registration by logging on to the service application running on the user device 104 and providing the user identifier by way of the service application.

Referring now to FIG. 9A, at step 902, the LPM server 110 receives the user identifier from the user device 104. At step 904, the LPM server 110 identifies the loyalty accounts of the user 102 (i.e., the first through third loyalty accounts 116a-116c) based on the user identifier. Identification of the loyalty accounts of the user 102 is explained in conjunction with FIG. 9B.

Referring now to FIG. 9B, at step 904a, the LPM server 110 communicates the first query, including the user identifier, to all the registered merchants and issuers for identifying the loyalty accounts that are associated with the user identifier. At step 904b, the LPM server 110 receives the responses to the first query from the registered merchants and issuers indicating whether the corresponding merchant or issuer manages a loyalty account of the user 102. The loyalty accounts of the user 102 are thus identified based on the received responses and the process returns to step 906 of FIG. 9A.

Referring back to FIG. 9A, at step 906, the LPM server 110 creates the centralized account 118 of the user 102 to register the user 102 for the centralized loyalty program. At step 908, the LPM server 110 communicates the centralized account information to the user device 104 for notifying the user 102 of the creation of the centralized account 118. At step 910, the LPM server 110 links the centralized account 118 to the first through third loyalty accounts 116a-116c of the user 102. The user 102 is thus registered with the LPM server 110 for the centralized loyalty program. At step 912, the LPM server 110 determines the loyalty points (i.e., the first plurality of loyalty points) stored in each of the first through third loyalty accounts 116a-116c based on the link between the first through third loyalty accounts 116a-116c and the centralized account 118. Determination of the loyalty points stored in the first through third loyalty accounts 116a-116c is explained in conjunction with FIG. 9C.

Referring now to FIG. 9C, at step 912a, the LPM server 110 communicates the second query to the first merchant server 106a, the second merchant server 106b, and the issuer server 108 for determining the loyalty points (i.e., the first plurality of loyalty points) stored in each of the first through third loyalty accounts 116a-116c, respectively. At step 912b, the LPM server 110 receives the responses to the second query from the first merchant server 106a, the second merchant server 106b, and the issuer server 108. The loyalty points stored in the first through third loyalty accounts 116a-116c are determined based on the received responses and the process returns to step 914 of FIG. 9A.

Referring back to FIG. 9A, at step 914, the LPM server 110 determines first through third conversion factors for the first through third loyalty accounts 116a-116c, respectively. At step 916, based on the first through third conversion factors, the LPM server 110 converts the loyalty points (i.e., the first plurality of loyalty points) stored in each of the respective first through third loyalty accounts 116a-116c to the loyalty points (i.e., the second plurality of loyalty points) associated with the centralized account 118. At step 918, the LPM server 110 credits the centralized account 118 with the converted loyalty points (i.e., the third plurality of loyalty points) of the first through third loyalty accounts 116a-116c. The centralized account 118 thus stores the sum of the converted loyalty points (i.e., the second plurality of loyalty points) of each of the first through third loyalty accounts 116a-116c.

At step 920, the LPM server 110 communicates the credit acknowledgements to the first merchant server 106a, the second merchant server 106b, the issuer server 108, and the user device 104 to indicate the credit of the centralized account 118. Based on the credit acknowledgements, the loyalty points stored in the first through third loyalty accounts 116a-116c are debited. At step 922, the LPM server 110 renders the first UI 602 on the user device 104 for presenting the loyalty points stored in the centralized account 118 to the user 102.

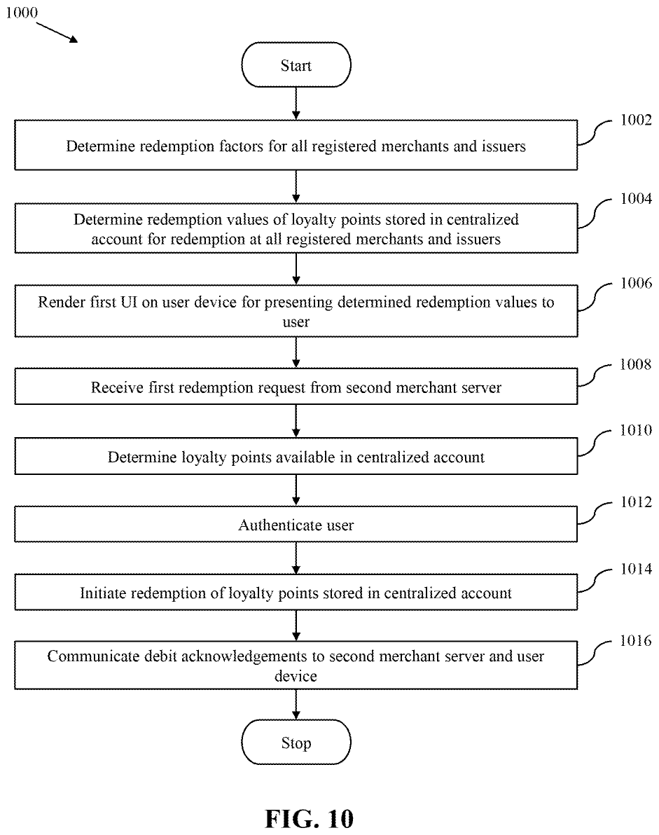

FIG. 10 represents a flow chart 1000 that illustrates a method for redeeming the loyalty points stored in the centralized account 118 of the user 102, in accordance with an exemplary embodiment of the disclosure. At step 1002, the LPM server 110 determines the redemption factors for all the registered merchants and issuers to enable redemption of the loyalty points (i.e., the third plurality of loyalty points) stored in the centralized account 118 at the registered merchants and issuers.

At step 1004, based on the determined redemption factors, the LPM server 110 determines the redemption values of the loyalty points stored in the centralized account 118 for redemption at all the registered merchants and issuers. At step 1006, the LPM server 110 renders the first UI 602 on the user device 104 for presenting the determined redemption values to the user 102. The presented redemption values assist the user 102 in selecting a registered merchant or a registered issuer for redeeming the loyalty points. For the sake of brevity, it is assumed that the user 102 chooses to redeem the loyalty points stored in the centralized account 118 at the second merchant.

The user 102 visits the second merchant for making a purchase and selects the first product for purchasing. The user 102 further provides the user identifier of the user 102 (or the account identifier of the centralized account 118) to the second merchant (or the operative associated with the second merchant) for initiating the redemption of loyalty points stored in the centralized account 118. The second merchant further provides the user identifier (or the account identifier) to the second merchant server 106b. At step 1008, the LPM server 110 receives the first redemption request, including the user identifier or the account identifier of the centralized account 118, from the second merchant server 106b.

At step 1010, the LPM server 110 determines the loyalty points available in the centralized account 118. At step 1012, the LPM server 110 authenticates the user 102 for the redemption. At step 1014, the LPM server 110 initiates the redemption of the loyalty points stored in the centralized account 118 by debiting at least a part of the loyalty points stored in the centralized account 118. At step 1016, the LPM server 110 communicates the debit acknowledgements to the second merchant server 106b and the user device 104 to indicate the debit of the centralized account 118.

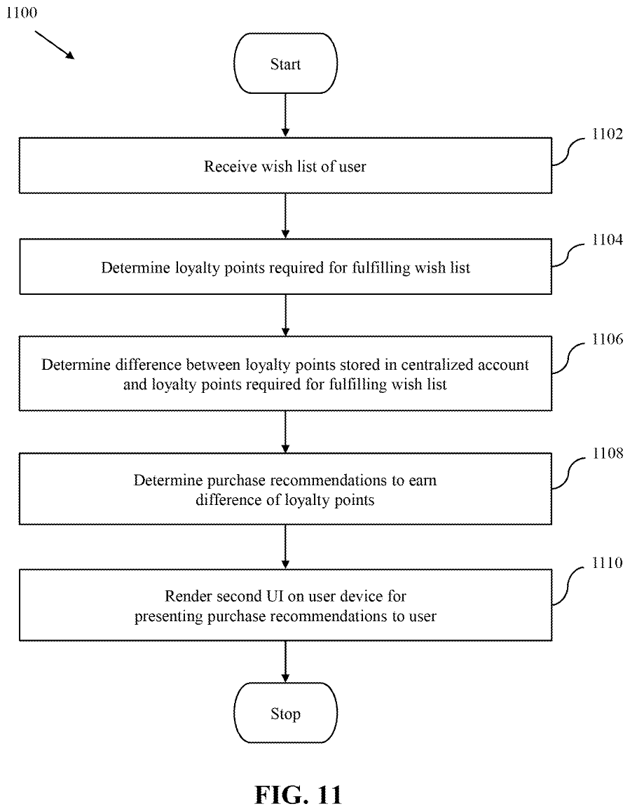

FIG. 11 represents a flow chart 1100 that illustrates a method for presenting the purchase recommendations to the user 102, in accordance with an exemplary embodiment of the disclosure. At step 1102, the LPM server 110 receives the wish list of the user 102 from the user device 104. The wish list may include various products that the user 102 intends to purchase in future. At step 1104, the LPM server 110 determines the loyalty points (i.e., the fourth plurality of loyalty points) required for fulfilling the wish list. At step 1106, the LPM server 110 determines the difference of loyalty points between the loyalty points stored in the centralized account 118 and the loyalty points required for fulfilling the wish list. At step 1108, the LPM server 110 determines the purchase recommendations for the user 102 to earn the difference of loyalty points. At step 1110, the LPM server 110 renders the second UI 608 on the user device 104 for presenting the purchase recommendations to the user 102.

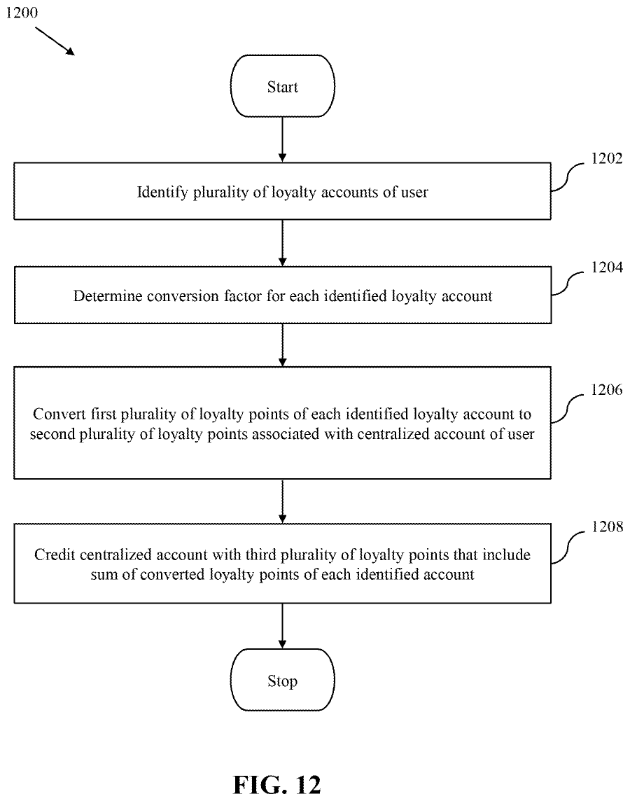

FIG. 12 represents a high-level flow chart 1200 that illustrates a method for loyalty points management, in accordance with an exemplary embodiment of the disclosure. At step 1202, the LPM server 110 identifies loyalty accounts of the user 102 (i.e., the first through third loyalty accounts 116a-116c). At step 1204, the LPM server 110 determines a conversion factor (i.e., the first through third conversion factors) for each identified loyalty account. At step 1206, the LPM server 110 converts, based on the conversion factor of each identified loyalty account, the first plurality of loyalty points of the corresponding loyalty account to the second plurality of loyalty points associated with the centralized account 118 of the user 102. At step 1208, the LPM server 110 credits the centralized account 118 with the third plurality of loyalty points. The third plurality of loyalty points include the summation of the converted loyalty points of each identified loyalty account. The credited loyalty points are redeemable by the user 102.

Technological improvements in the LPM server 110 enable the LPM server 110 to collate all the loyalty points earned by the user 102 in different loyalty accounts (e.g., the first through third loyalty accounts 116a-116c), in a single centralized account (i.e., the centralized account 118). The loyalty points stored in the centralized account 118 are redeemable at all the registered merchants and issuers. Thus, the user 102 is able to redeem the loyalty points earned at one merchant (e.g., the first merchant), at any other registered merchant (e.g., the second merchant) or issuer (e.g., the first issuer). Further, the user 102 is also able to redeem the loyalty points in the centralized account 118 at merchants and issuers that do not manage a loyalty account of the user 102. Further, the loyalty points in the centralized account 118 do not expire, i.e., the loyalty points are available until the loyalty points are redeemed. This ensures that the user 102 does not miss out on any loyalty point benefits. Further, the collation of the loyalty points in the centralized account 118 makes it easy for the user 102 to keep track of the loyalty points earned by the user 102 at various merchants and issuers. Further, the redemption values of the loyalty points in the centralized account 118 for redemption at all the registered merchants and issuers are presented to the user 102. The presented redemption values assist the user 102 in selecting a registered merchant or a registered issuer for redeeming the loyalty points stored in the centralized account 118. Similarly, the purchase recommendations presented to user 102 assists the user 102 in fulfilling the wish list of the user 102. Thus, the centralized loyalty program of the disclosure manages the loyalty points of the user 102 in a more efficient manner as compared to conventional loyalty programs.

Techniques consistent with the disclosure provide, among other features, systems, and methods for managing loyalty points of users (e.g., the user 102). While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an”, as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

We claim:

1. A loyalty points management method, comprising:
identifying, by a server, a plurality of loyalty accounts of a user, wherein each of the plurality of loyalty accounts stores a first plurality of loyalty points;
determining, by the server, a conversion factor for each loyalty account of the plurality of loyalty accounts, the conversion factor for a given loyalty account in the plurality of loyalty accounts of the user defines an equivalence between loyalty points stored in the given loyalty account and loyalty points associated with a centralized account of the user for a centralized loyalty program;
converting, by the server, based on the conversion factor associated with each loyalty account, the first plurality of loyalty points of the corresponding loyalty account to a second plurality of loyalty points, wherein the loyalty points of each loyalty account in the plurality of loyalty accounts are converted to loyalty points of the centralized account based on the corresponding conversion factor for each loyalty account; and
crediting, by the server, the centralized account of the user with a third plurality of loyalty points, wherein the third plurality of loyalty points include the second plurality of loyalty points associated with each loyalty account, and wherein the credited third plurality of loyalty points are redeemable by the user at any merchant or issuer registered by the server for the centralized loyalty program.

2. The loyalty points management method of claim 1, wherein each loyalty account is associated with a merchant or an issuer, wherein the loyalty points earned at a first merchant or first issuer converted to loyalty points of the centralized account are redeemable at a second merchant or second issuer, and wherein the loyalty points in the centralized account do not expire.

3. The loyalty points management method of claim 1, further comprising receiving, by the server, a user identifier of the user, wherein the plurality of loyalty accounts are identified based on the user identifier.

4. The loyalty points management method of claim 3, wherein the user identifier corresponds to one of a contact number of the user, an electronic mail identifier of the user, or a unique username of the user.

5. The loyalty points management method of claim 1, wherein the conversion factor associated with each loyalty account is a dynamic conversion factor determined based on a spend history of a merchant or an issuer associated with the corresponding loyalty account, and further comprising:
changing the conversion factor for a given registered merchant based on a change in the spend history of the registered merchant; and
updating a redemption value for a given loyalty account corresponding to the given registered merchant based on the changed conversion factor.

6. The loyalty points management method of claim 1, wherein the first plurality of loyalty points are debited from each loyalty account based on the credit of the third plurality of loyalty points to the centralized account.

7. The loyalty points management method of claim 1, further comprising linking, by the server upon the identification of the plurality of loyalty accounts, the centralized account to the plurality of loyalty accounts.

8. The loyalty points management method of claim 1, further comprising:
receiving, by the server, a redemption request for redeeming the third plurality of loyalty points against a purchase, wherein the redemption request includes a user identifier linked to the centralized account or an account identifier of the centralized account; and
initiating, by the server, the redemption of the third plurality of loyalty points by debiting at least a part of the third plurality of loyalty points from the centralized account.

9. The loyalty points management method of claim 1, further comprising:
determining, by the server, a redemption value of the third plurality of loyalty points for redeeming the third plurality of loyalty points at a merchant or an issuer; and
rendering, by the server, a user interface on a user device of the user to present the third plurality of loyalty points and the determined redemption value for redeeming the third plurality of loyalty points at the merchant or the issuer.

10. The loyalty points management method of claim 1, further comprising:
receiving, by the server, a wish list of the user, wherein the wish list includes one or more products;
determining, by the server, a fourth plurality of loyalty points required for fulfilling the wish list;
determining, by the server, a difference of loyalty points between the third plurality of loyalty points and the fourth plurality of loyalty points;
determining, by the server, one or more purchase recommendations for the user to earn the difference of loyalty points; and
rendering, by the server, a user interface on a user device of the user to present the one or more purchase recommendations, wherein the one or more purchase recommendations include at least a purchase at a merchant or a purchase at an issuer.

11. A loyalty points management system, comprising:
a server comprising at least one processor and at least one memory comprising computer program code that, when executed by the at least one processor, is operable to:
identify a plurality of loyalty accounts of a user, wherein each of the plurality of loyalty accounts stores a first plurality of loyalty points;
determine a conversion factor for each loyalty account of the plurality of loyalty accounts, the conversion factor for a given loyalty account in the plurality of loyalty accounts of the user defines an equivalence between loyalty points stored in the given loyalty account and loyalty points associated with a centralized account of the user for a centralized loyalty program;
convert, based on the conversion factor associated with each loyalty account, the first plurality of loyalty points of the corresponding loyalty account to a second plurality of loyalty points, wherein the loyalty points of each loyalty account in the plurality of loyalty accounts are converted to loyalty points of the centralized account based on the corresponding conversion factor for each loyalty account; and
credit the centralized account of the user with a third plurality of loyalty points, wherein the third plurality of loyalty points include the second plurality of loyalty points associated with each loyalty account, and wherein the credited third plurality of loyalty points are redeemable by the user at any merchant or issuer registered by the server for the centralized loyalty program.

12. The loyalty points management system of claim 11, wherein each loyalty account is associated with a merchant or an issuer, and wherein the loyalty points earned at a first merchant or first issuer converted to loyalty points of the centralized account are redeemable at a second merchant or second issuer, and wherein the loyalty points in the centralized account do not expire.

13. The loyalty points management system of claim 11, wherein the server receives a user identifier of the user, and wherein the plurality of loyalty accounts are identified based on the user identifier.

14. The loyalty points management system of claim 13, wherein the user identifier corresponds to one of a contact number of the user, an electronic mail identifier of the user, or a unique username of the user.

15. The loyalty points management system of claim 11, wherein the conversion factor associated with each loyalty account is a dynamic conversion factor determined based on a spend history of a merchant or an issuer associated with the corresponding loyalty account and wherein the server is further operable to:
change the conversion factor for a given registered merchant based on a change in the spend history of the registered merchant; and
update a redemption value for a given loyalty account corresponding to the given registered merchant based on the changed conversion factor.

16. The loyalty points management system of claim 11, wherein the first plurality of loyalty points are debited from each loyalty account based on the credit of the third plurality of loyalty points to the centralized account.

17. The loyalty points management system of claim 11, wherein the server is further operable to link, upon the identification of the plurality of loyalty accounts, the centralized account to the plurality of loyalty accounts.

18. The loyalty points management system of claim 11, wherein the server is further operable to:
receive a redemption request for redeeming the third plurality of loyalty points against a purchase, wherein the redemption request includes a user identifier linked to the centralized account or an account identifier of the centralized account; and
initiate the redemption of the third plurality of loyalty points by debiting at least a part of the third plurality of loyalty points from the centralized account.

19. The loyalty points management system of claim 11, wherein the server is further operable to:
determine a redemption value of the third plurality of loyalty points for redeeming the third plurality of loyalty points at a merchant or an issuer; and
render a user interface on a user device of the user to present the third plurality of loyalty points and the determined redemption value for redeeming the third plurality of loyalty points at the merchant or the issuer.

20. The loyalty points management system of claim 11, wherein the server is further operable to:
receive a wish list of the user, wherein the wish list includes one or more products;
determine a fourth plurality of loyalty points required for fulfilling the wish list;
determine a difference of loyalty points between the third plurality of loyalty points and the fourth plurality of loyalty points;
determine one or more purchase recommendations for the user to earn the difference of loyalty points; and
render a user interface on a user device of the user to present the one or more purchase recommendations, wherein the one or more purchase recommendations include at least a purchase at a merchant or a purchase at an issuer.
